(19) United States
(12) Patent Application Publication
(10) Pub. No.: US 2024/0402460 A1
(43) Pub. Date: Dec. 5, 2024

(54) PRISM FIXING STRUCTURE OF OPTICAL MACHINE AND PROJECTION OPTICAL MACHINE

(71) Applicant: GOERTEK OPTICAL TECHNOLOGY CO., LTD., Weifang (CN)

(72) Inventors: Qiang ZHANG, Weifang (CN); Rongpeng CUI, Weifang (CN); Wengang GAO, Weifang (CN)

(21) Appl. No.: 18/783,960

(22) Filed: Jul. 25, 2024

Related U.S. Application Data
(63) Continuation of application No. PCT/CN2022/101514, filed on Jun. 27, 2022.

(30) Foreign Application Priority Data
May 23, 2022 (CN) 202210565602.6

(51) Int. Cl. G02B 7/18; G03B 21/20

(52) U.S. Cl. CPC G02B 7/1805; G03B 21/208

(57) ABSTRACT

Disclosed are a prism fixing structure of the optical machine and a projection optical machine. The prism fixing structure of an optical machine includes a body and a prism, the body is provided with a slot, a bearing surface and a baffle, and the prism includes a first side edge, a second side edge and a hypotenuse connected end to end; a glue point is provided between the first side edge and the bearing surface, the hypotenuse is fitted with the baffle, and an oblique angle end formed by the second side edge and the hypotenuse is clamped in the slot.

### CROSS-REFERENCE TO RELATED APPLICATIONS

This application is a continuation application of International Application No. PCT/CN2022/101514, filed on Jun. 27, 2022, which claims priority to Chinese Patent Application No. 202210565602.6, filed on May 23, 2022. The disclosures of the above-mentioned applications are incorporated herein by reference in their entireties.

### TECHNICAL FIELD

The present application relates to the technical field of projection optical machine, and in particular to a prism fixing structure of an optical machine and a projection optical machine.

### BACKGROUND

With the development of micro-projector technology, more and more household projection optical machines have entered people's field of vision. However, as the lighting time of the projection optical machine increases, an inevitable problem will occur, that is, defocus, which is an important parameter that can measure the quality of projection. Specifically, because the internal temperature of the projection optical machine rises sharply due to long-term work, the fixed glue point produces thermal expansion to cause the prism to shift from its original position, thereby causing the projection picture to be defocused. Therefore, ensuring that the prism is fixed in the original position and reducing the position offset are important strategies to improve thermal defocus. Through experimental verification, the position of the prism in the optical machine is the most important factor, and fixing the prism can effectively reduce thermal defocus.

In view of this, it is necessary to provide a new prism fixing structure of an optical machine and a projection optical machine to solve or at least alleviate the above technical defects.

### SUMMARY

The main purpose of the present application is to provide a prism fixing structure of an optical machine and a projection optical machine, aiming to solve the technical problem of defocusing produced in the projection optical machine in the prior art.

To achieve the above purpose, according to one aspect of the present application, the present application provides a prism fixing structure of an optical machine, including a body and a prism, the body is provided with a slot, a bearing surface and a baffle, and the prism includes a first side edge, a second side edge and a hypotenuse connected end to end; a glue point is provided between the first side edge and the bearing surface, the hypotenuse is fitted with the baffle, and an oblique angle end formed by the second side edge and the hypotenuse is clamped in the slot.

In an embodiment, the baffle includes a horizontal plate and a vertical plate connected the horizontal plate, the horizontal plate is connected to the body, and the vertical plate is parallel to and fitted with the hypotenuse.

In an embodiment, a boss is provided on the body, the boss is abutted against a bottom surface of the prism, and a thickness of the horizontal plate and a height of the boss are identical.

In an embodiment, the bearing surface is parallel to the first side edge, and the bearing surface is fitted with the first side edge except for a position of the glue point.

In an embodiment, the bearing surface includes at least two sub-bearing surfaces provided at intervals, and each of the sub-bearing surfaces is provided with the glue point.

In an embodiment, at least two glue points are provided, and heights of the at least two glue points are identical.

In an embodiment, a width of the slot is gradually expanded from a bottom of the slot to an opening of the slot, and one side of the slot is parallel to and partially fitted with the second side edge.

In an embodiment, the baffle is integrally molded with the body.

In an embodiment, the prism is a right-angle triangular prism, and the first side edge and the second side edge are perpendicular to each other.

In an embodiment, a thickness of the glue point is 0.9 mm to 1.1 mm.

According to another aspect of the present application, the present application further provides a projection optical machine, including the prism fixing structure of the optical machine described above.

In the above scheme, the prism fixing structure of an optical machine includes a body and a prism, the body is provided with a slot, a bearing surface and a baffle, and the prism includes a first side edge, a second side edge and a hypotenuse connected end to end; a glue point is provided between the first side edge and the bearing surface, the hypotenuse is fitted with the baffle, and an oblique angle end formed by the second side edge and the hypotenuse is clamped in the slot. By changing the position of glue point, dispensing glue on the bearing surface between prism and the body of the optical machine, and designing the baffle on hypotenuse of prism; when optical machine is lighted up, due to the rise in temperature, the glue point is expanded due to heat to exert the effect of force on prism, and prism will be pushed forward. When the baffle is not designed, prism will move along the direction of force F; while after adding the baffle, prism moves in advance and baffle generates support force Fn and static friction force Fr on prism. Moreover, because the force exerted by the expansion of glue point on prism is relatively small, the support force Fn and static friction force Fr exerted by baffle on prism are sufficient to balance the acting force exerted by glue point on prism. Therefore, the prism can remain relatively still and will not shift. This embodiment changes the glue dispensing position and adds a baffle at the hypotenuse of the prism, ensuring that the position of the prism will not shift due to the heating up and expansion of the glue point when the optical machine is used for a long time, thus effectively avoiding the occurrence of the defocus phenomenon.

### BRIEF DESCRIPTION OF THE DRAWINGS

In order to explain the embodiments of the present application or the technical solutions in the existing technology more clearly, the accompanying drawings needed to be used in the description of the embodiments or the existing technology will be briefly introduced below. Obviously, the accompanying drawings in the following description are only some embodiments of the present application, other accompanying drawings can be obtained based on the provided accompanying drawings without exerting creative efforts for those skilled in the art.

FIG. 1 is a top view of a prism fixing structure of an optical machine of an embodiment of the present application.

FIG. 2 is an enlarged view of FIG. 1 at point A.

FIG. 3 is a three-dimensional structural schematic view of a prism fixing structure of an optical machine of an embodiment of the present application.

FIG. 4 is a partial structural schematic view of a prism fixing structure of an optical machine of an embodiment of the present application (excluding the prism).

FIG. 5 is a three-dimensional structural schematic view of a baffle of an embodiment of the present application.

FIG. 6 is a force analysis diagram of a prism and a baffle of an embodiment of the present application.

The realization of the purpose, functional features and advantages of the present application will be further described in conjunction with the embodiments and with reference to the accompanying drawings.

### DETAILED DESCRIPTION OF THE EMBODIMENTS

The technical solutions in the embodiments according to the present application will be clearly and completely described below in conjunction with the accompanying drawings in the embodiments according to the present application, and it is clear that the described embodiments are only a part of the embodiments according to the present application, and not all of the embodiments. Based on the embodiments in the present application, all other embodiments obtained by those skilled in the art without making creative labor fall within the scope of the present application.

It should be noted that in the embodiment of the present application, all directional indications (such as up, down or the like) are only used to explain the relative positional relationship, movement and so on between various components in a specific posture (as shown in the accompanying drawings). If the specific posture changes, the directional indication will also change accordingly.

In addition, in the present application, if there are descriptions involving “first”, “second” or the like, they are only for descriptive purposes and cannot be understood as indicating or implying the relative importance or implicitly indicating the quantity of the technical features indicated. Therefore, features defined as “first” and “second” may explicitly or implicitly include at least one of these features.

Moreover, the technical solutions between the various embodiments of the present application can be combined with each other, but it must be based on that those skilled in the art can realize. When the combination of technical solutions is contradictory or cannot be realized, it should be considered that such combination of technical solutions does not exist and is not within the protection scope claimed by the present application.

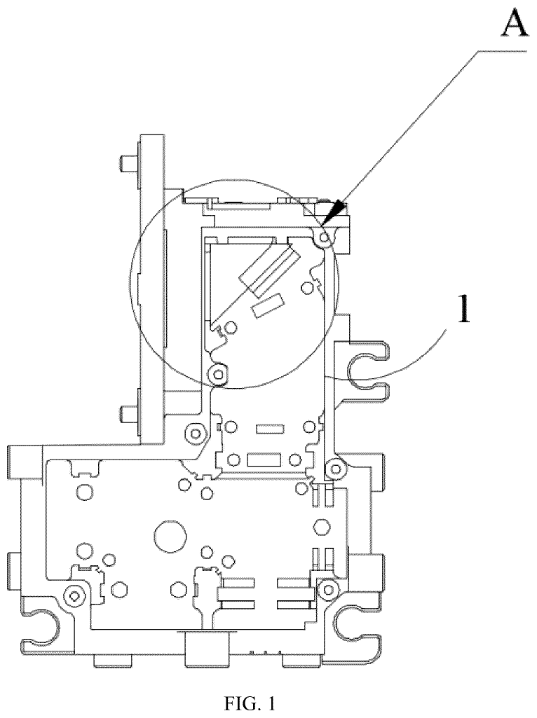

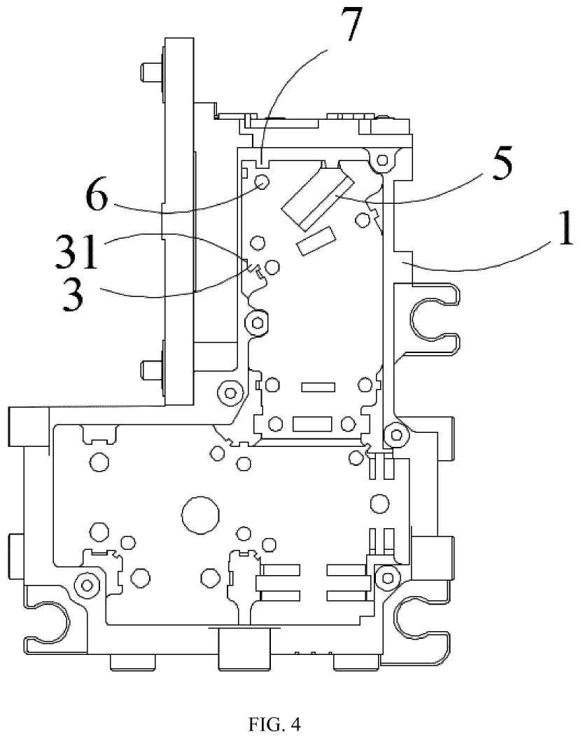

Referring to FIG. 1 to FIG. 4, according to one aspect of the present application, the present application provides a prism fixing structure of an optical machine, including a body 1 and a prism 2. The body 1 is provided with a slot 3, a bearing surface 7 and a baffle 5, and the prism 2 includes a first side edge 21, a second side edge 22 and a hypotenuse 23 connected end to end. A glue point 4 is provided between the first side edge 21 and the bearing surface 7, the hypotenuse 23 is fitted with the baffle 5, and an oblique angle end 24 formed by the second side edge 22 and the hypotenuse 23 is clamped in the slot 3.

The traditional glue dispensing method is to open three holes on the body 1 of the optical machine at the bottom of the prism 2 and perform pouring glue injection. When the optical machine is working normally, the temperature inside the cavity of the optical machine and the body 1 of the optical machine rises, causing the glue point 4 to expand due to heat, and the expansion exerts a force on the prism 2. Since the thermal expansion coefficients of the same glue point 4 are identical, the expansion degree is positively correlated with the temperature, that is, the force exerted by the glue point 4 on the prism 2 is positively correlated with the temperature. The specific calculation formula is: f=a*^{Δ}t, a is the thermal expansion coefficient of the glue point 4, and ^{Δ}t is the temperature variation at different positions. Since the temperatures of glue point's positions are different, the glue points 4 at different positions exert different forces on the prism 2, and the prism 2 is subjected to uneven force, which can easily cause different degrees of displacement at different positions of the prism 2, thus resulting in a defocus phenomenon.

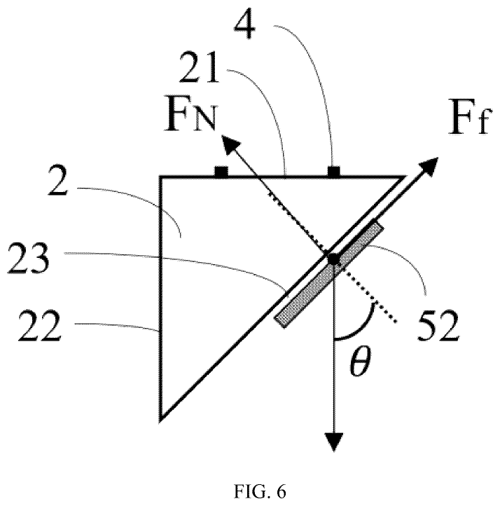

In the above embodiment, by changing the position of glue point 4, dispensing glue on the bearing surface 7 between prism 2 and the body 1 of the optical machine, and designing the baffle 5 on hypotenuse 23 of prism 2; when optical machine is lighted up, due to the rise in temperature, the glue point 4 is expanded due to heat to exert the effect of force on prism 2, and prism 2 will be pushed forward. The specific force analysis is shown in FIG. 6, F is the effect of the comprehensive force of glue point 4 on prism 2. When baffle 5 is not designed, prism 2 will move along the direction of force F; while after adding the baffle 5, prism 2 moves in advance and baffle 5 generates support force Fn and static friction force Fr on prism 2. Moreover, because the force exerted by the expansion of glue point 4 on prism 2 is relatively small, the support force Fn and static friction force Fr exerted by baffle 5 on prism 2 are sufficient to balance the acting force exerted by glue point 4 on prism 2, and the three satisfy the force equilibrium condition, that is:

$$\begin{matrix}Fn = F cos θ \\ Ff = F sin θ\end{matrix}$$

Therefore, the prism 2 can remain relatively still and will not shift. This embodiment changes the glue dispensing position and adds a baffle 5 at the hypotenuse 23 of the prism 2, ensuring that the position of the prism 2 will not shift due to the heating up and expansion of the glue point 4 when the optical machine is used for a long time, thus effectively avoiding the occurrence of the defocus phenomenon.

Specifically, referring to FIG. 1 to FIG. 3, the prism 2 is a right-angle triangular prism, and the first side edge 21 and the second side edge 22 are perpendicular to each other. The prism 2 is an important optical element for optical machine imaging, which is configured to change the propagation direction of light so that the reflected light propagates along a fixed position during lens transmission. The present application sets the glue point 4 at the first side edge 21, firstly, because there is no bearing surface 7 at the second side edge 22; moreover, there is a gap between the body 1 and the prism 2 at the second side edge 22, and the temperature is high; if glue is dispensed here, it is easy to cause the glue point 4 to expand too much to push the prism 2 to rotate and the glue point 4 to age.

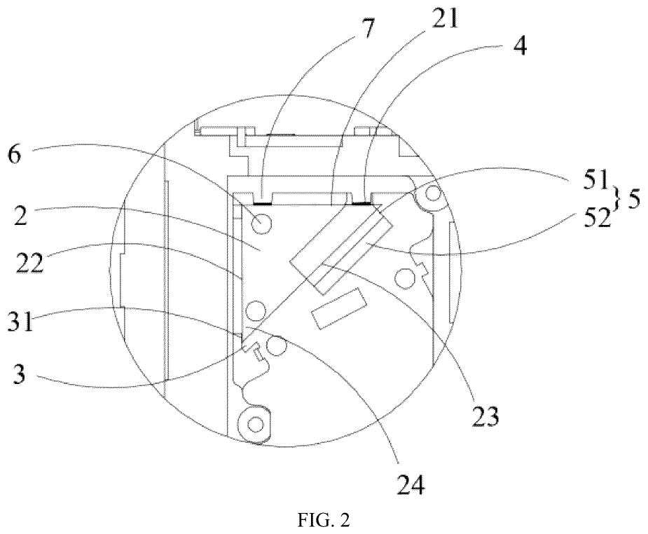

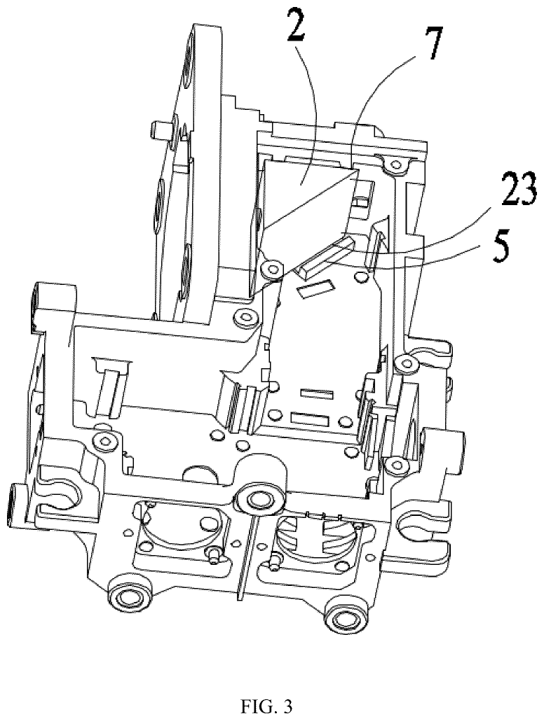

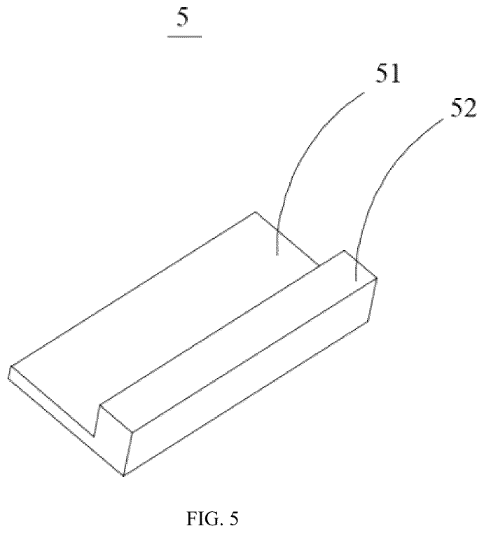

In an embodiment, referring to FIG. 2, FIG. 3 and FIG. 5, the baffle 5 includes a horizontal plate 51 and a vertical plate 52 connected the horizontal plate 51, the horizontal plate 51 is connected to the body 1, and the vertical plate 52 is parallel to and fitted with the hypotenuse 23. The horizontal plate 51 and the vertical plate 52 can be vertically connected, the horizontal plate 61 is configured to connect with the body 1, and the vertical plate 52 is parallel to and fitted with the hypotenuse 23, which is configured to provide effective fixed action for the hypotenuse 23. Certainly, a plurality of baffles 5 can be designed here, and the plurality of baffles 5 are provided at intervals along the extension direction of the hypotenuse 23. The plurality of vertical plates 52 are fitted with the hypotenuse 23 to offset the acting force of the glue point 4 that expand due to heat on the prism 2, thus ensuring that the prism 2 is fixed without deviation, and avoiding the occurrence of defocus phenomenon.

In an embodiment, a boss 6 is provided on the body 1, the boss 6 is abutted against a bottom surface of the prism 2, and a thickness of the horizontal plate 51 and a height of the boss 6 are identical. The boss 6 is configured for playing a role in positioning and supporting, and the thickness of the horizontal plate 51 is identical to the height of the boss 6, thus ensuring that the prism 2 is at the same horizontal height; and the height of the vertical plate 52 is lower than the lower edge of the effective light area of the prism 2, thus avoiding shading while fixing the prism 2.

In an embodiment, the bearing surface 7 is parallel to the first side edge 21, and the bearing surface 7 is fitted with the first side edge 21 except for a position of the glue point 4. The bearing surface 7 here is a whole plane, and the bearing surface 7 is parallel to the first side edge 21 and is fitted with a setting for positioning the prism 2.

In an embodiment, the bearing surface 7 includes at least two sub-bearing surfaces provided at intervals, and each of the sub-bearing surfaces is provided with the glue point 4. The bearing surface 7 is a side positioning surface of the prism 2, ensuring that there is a certain distance between the prism 2 and the DMD (Digital Micromirror Device). When the bearing surface 7 includes at least two sub-bearing surfaces, at least two glue points 4 are provided, and heights of the at least two glue points 4 are identical. The identical height of the glue points 4 means that the glue points 4 are at the same horizontal height, so that the prism 2 will not tilt due to uneven force in the vertical direction (the height direction of the prism 2). In addition, the horizontal plate 51 can be connected to one of the sub-bearing surfaces, which makes it more convenient to support the prism 2.

In an embodiment, a width of the slot 3 is gradually expanded from a bottom of the slot 3 to an opening of the slot 3, and one side 31 of the slot 3 is parallel to and partially fitted with the second side edge 22. The slot 3 is configured to fix the prism 2, and there is a small gap with the oblique angle end 24 of the prism 2 for easy installation. To ensure tight installation, one side 31 of the slot 3 is fitted with the second side edge 22 of the prism 2 to ensure that the prism 2 does not move. Certainly, the “fitted with” mentioned here only means that one side 31 of the slot 3 overlaps with the part of the second side edge 22 at the oblique angle end 24, rather than the one side 31 of the slot 3 being fitted with the entire second side edge 22.

In an embodiment, the baffle 5 is integrally molded with the body 1. The baffle 5 is made of the same material as the body 1. Adopting the integrated molding production is more solid and more convenient to manufacture

In an embodiment, a thickness of the glue point 4 is 0.9 mm to 1.1 mm. The glue dispensing thickness is defined according to the amount of glue, and more specifically, it can be 1.0 mm.

According to another aspect of the present application, the present application further provides a projection optical machine, including the prism fixing structure of the optical machine mentioned above. Since the projection optical machine includes all the technical solutions of all the embodiments of the prism fixing structure of the optical machine mentioned above, it has at least all the beneficial effects brought by all the above technical solutions, which will not be repeated here.

The above are only some embodiments of the present application, and are not intended to limit the scope of the present application. Under the inventive concept of the present application, any equivalent structure transformation made by using the description and accompanying drawings of the present application, or directly or indirectly applied in other related technical fields, is included within the scope of the present application.

What is claimed is:

1. A prism fixing structure of an optical machine, comprising:
a body; and
a prism, wherein:
the body is provided with a slot, a bearing surface and a baffle, and the prism comprises a first side edge, a second side edge and a hypotenuse connected end to end; a glue point is provided between the first side edge and the bearing surface, the hypotenuse is fitted with the baffle, and an oblique angle end formed by the second side edge and the hypotenuse is clamped in the slot.

2. The prism fixing structure of the optical machine according to claim 1, wherein the baffle comprises a horizontal plate and a vertical plate connected the horizontal plate, the horizontal plate is connected to the body, and the vertical plate is parallel to and fitted with the hypotenuse.

3. The prism fixing structure of the optical machine according to claim 2, wherein a boss is provided on the body, the boss is abutted against a bottom surface of the prism, and a thickness of the horizontal plate and a height of the boss are identical.

4. The prism fixing structure of the optical machine according to claim 1, wherein the bearing surface is parallel to the first side edge, and the bearing surface is fitted with the first side edge except for a position of the glue point.

5. The prism fixing structure of the optical machine according to claim 1, wherein the bearing surface comprises at least two sub-bearing surfaces provided at intervals, and each of the sub-bearing surfaces is provided with the glue point.

6. The prism fixing structure of the optical machine according to claim 5, wherein at least two glue points are provided, and heights of the at least two glue points are identical.

7. The prism fixing structure of the optical machine according to claim 1, wherein a width of the slot is gradually expanded from a bottom of the slot to an opening of the slot, and one side of the slot is parallel to and partially fitted with the second side edge.

8. The prism fixing structure of the optical machine according to claim 1, wherein the baffle is integrally molded with the body.

9. The prism fixing structure of the optical machine according to claim 1, wherein the prism is a right-angle triangular prism, and the first side edge and the second side edge are perpendicular to each other.

10. The prism fixing structure of the optical machine according to claim 1, wherein a thickness of the glue point is 0.9 mm to 1.1 mm.

11. A projection optical machine, comprising the prism fixing structure of the optical machine according to claim 1.
